(19) United States
(12) Patent Application Publication
(10) Pub. No.: US 2009/0245070 A1
(43) Pub. Date: Oct. 1, 2009

(54) Suspension Arm Actuator For an Optical Scanning Device

(76) Inventors: Michael Bammert, Hardt (DE); Tsuneo Suzuki, Moenchweiler (DE); Rolf Dupper, Villingen-Schwenningen (DE)

Correspondence Address: Thomson Licensing LLC, P.O. Box 5312, Two Independence Way, PRINCETON, NJ, 08543-5312, US

(21) Appl. No.: 12/309,551

(22) PCT Filed: Jul. 13, 2007
(86) PCT No.: PCT/EP2007/057228

§ 371 Date: Jan. 22, 2009

(30) Foreign Application Priority Data
Jul. 27, 2006 (DE) 102006034733.1

(51) Int. Cl. G11B 7/135

(52) U.S. Cl. 369/112.23; G9B/7.112

(57) ABSTRACT

The invention relates to a suspension arm actuator for an optical scanning device, comprising a suspension arm designed as a two-arm lever and allocated to an optical recording carrier. The suspension arm is, in known manner, mounted to a support between the lever arms such that it can be pivoted about an axis extending perpendicularly to said suspension arm. On its end side, one of the lever arms supports an optical head having optical components, in particular having an objective lens, while a magnetic drive initiating a swivel motion about the axis is allocated to the other lever arm. In addition, the suspension arm actuator comprises a magnetic drive initiating a motion perpendicular to this swivel motion and electric connections between a control unit arranged outside of said suspension arm actuator and the electrical and optical components. The invention solves the problem of designing such a suspension arm actuator such that said suspension arm actuator allows arrangement of an increased number of optical components while keeping or being reduced in its height. To achieve this, electric connections are established by means of line sections arranged at the suspension arm in a plane extending in transverse direction in relation to the axis spaced apart radially from the axis and spaced apart from each other, said line sections each being electrically connected to a contact element for connection of a control line running to the control unit.

The invention relates to a suspension arm actuator for an optical scanning device, said suspension arm actuator being of the two-arm-lever type and comprising an optical head having an objective lens, to be arranged in a device for recording and/or reproducing information.

A suspension arm actuator arranged in an optical scanning device may be designed with two arms and mounted such that it can be pivoted about an axis between said two arms. An optical head having a objective lens and intended for emission of a light beam (laser beam) onto an optical recording carrier designed as an information carrier, in particular an optical disk, and for reception of the beam reflected by said optical recording carrier is arranged at the end of one of said two arms. Therein, the recording carrier is supported by a supporting device and is caused to make a rotational motion. The end of the suspension arm, which is provided with the optical head, is movable in the form of an arc in a plane extending in parallel to the recording surface of the recording carrier (tracking) and in vertical direction in relation to this plane (focusing). To achieve this, the suspension arm actuator is, usually, provided with magnetic drives, wherein at least that one of said magnetic drives that is intended for the tracking motion is allocated to the other arm of the suspension arm. Such suspension arm actuators which allow to achieve short times of access to various locations on the recording carrier are, for example, described in US 2004/ 0148619 A1, in US 2005/ 0240952 A1, in KR 2004100645 A1, and in KR 1020040108029 A.

The optical head arranged on the suspension arm and also the coils of the magnetic drives are connected, through control lines, to a control unit (servo system) arranged outside of the suspension arm, this being, in particular, achieved by means of flexible lines and lines integrated in the suspension arm. The development and the application of scanning devices and, therefore, of suspension arm actuators as well display a tendency towards a reduction in size and flatter design thereof, in particular for portable devices, thereby reducing the inertia of the suspension arm and facilitating further shortening of access times. It is, in addition, contemplated whether an increasing number of optical components, such as laser diode, detector, monitor diode, or mirror, should be allocated to and arranged on the suspension arm actuator in order to achieve a more compact design of the scanning device (pick up). However, the displacement of further optical components onto the suspension arm actuator also requires an increased number of electric control lines between the individual components and the control unit arranged outside of the actuator. The usually used flexible printed lines or flexible printed circuit boards require a construction height which works against and limits the reduction in size of the scanning devices, in particular in their height.

The invention aims at designing a suspension arm actuator for an optical scanning device according to the preamble of claim 1 such that said suspension arm actuator allows arrangement of an increased number of optical components while keeping or being reduced in its height.

This problem is solved by a suspension arm actuator according to the preamble of claim 1 by means of its characterizing elements. Advantageous embodiments are presented in the dependent claims.

The invention consists of the fact that the electric connection lines that are arranged on the suspension arm and connect the optical and electrical components provided thereon to a control unit provided outside thereof are formed by means of line sections which are arranged in a plane extending in transverse direction in relation to the pivot axis, said line sections further being arranged on the suspension arm spaced apart radially from the pivot axis and spaced apart from each other, while each being electrically connected to a contact element for connection of a control line running to the control unit. This arrangement allows accommodation of a multitude of connection lines on the suspension arm that is movable and/or pivoting opposite to the control unit, in particular in the vicinity of the pivot bearing, without increasing the construction height of the suspension arm. Contrary to the flexible cables that have usually been used hitherto, this allows the design of flatter scanning systems.

Therein, the line sections can, at a two-part contact crosspiece that is arranged on the suspension arm in a non-rotatable manner and is extending in the direction of the longitudinal axis of said suspension arm, be in contact with lines integrated in said contact crosspiece, the parts of which are arranged on either side of the pivot bearing but are not connected thereto. The part facing away from the optical head is provided with contact elements, preferably contacting areas, allowing electric connection to the control lines running to the control unit. Advantageously, the line sections are self-supporting wire lines on either side of the longitudinal axis, said wire lines enclosing the pivot bearing while being spaced apart radially therefrom and spaced apart from each other. The points where the wire lines are contacting the lines integrated in the two-part contact crosspiece are formed in parallel to the longitudinal axis on either side of said contact crosspiece or, rather, on either side of the two parts of said contact crosspiece.

Alternatively, however, the contact crosspiece that is provided with integrated lines can also be extending in transverse direction in relation to the pivot axis of the suspension arm and be in electric contact with a printed circuit board permanently attached to the support, said electric contact being achieved by means of relatively short line sections designed to form sliding contacts (sliding brush arrangement) and contact tracks spaced apart from each other and arranged concentrically in relation to the pivot axis being formed on said printed circuit board. Once the suspension arm makes a swivel motion, the line sections are sliding on the contact tracks which are, on their end side, provided with contact elements, preferably contacting areas, for electric connection to the control lines running to the control unit. As compared with the arrangement described above, this is to advantage in that the inertia is reduced to a greater extent, because the mass of moving parts is kept smaller. The contact tracks are to further advantage in that they can be applied directly to the support for the suspension arm.

Below, the invention will be illustrated by means of two exemplary embodiments. In the related schematic drawings,

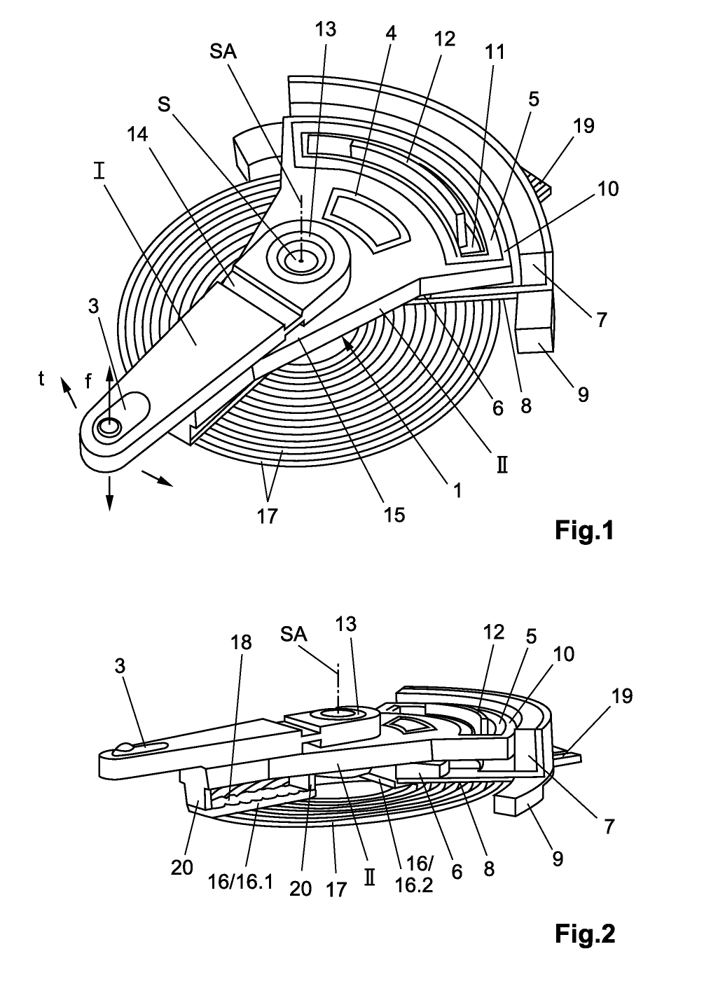

FIG. 1 is a top view of a suspension arm actuator with self-supporting wire lines, in perspective;

FIG. 2 is a lateral view thereof, in perspective;

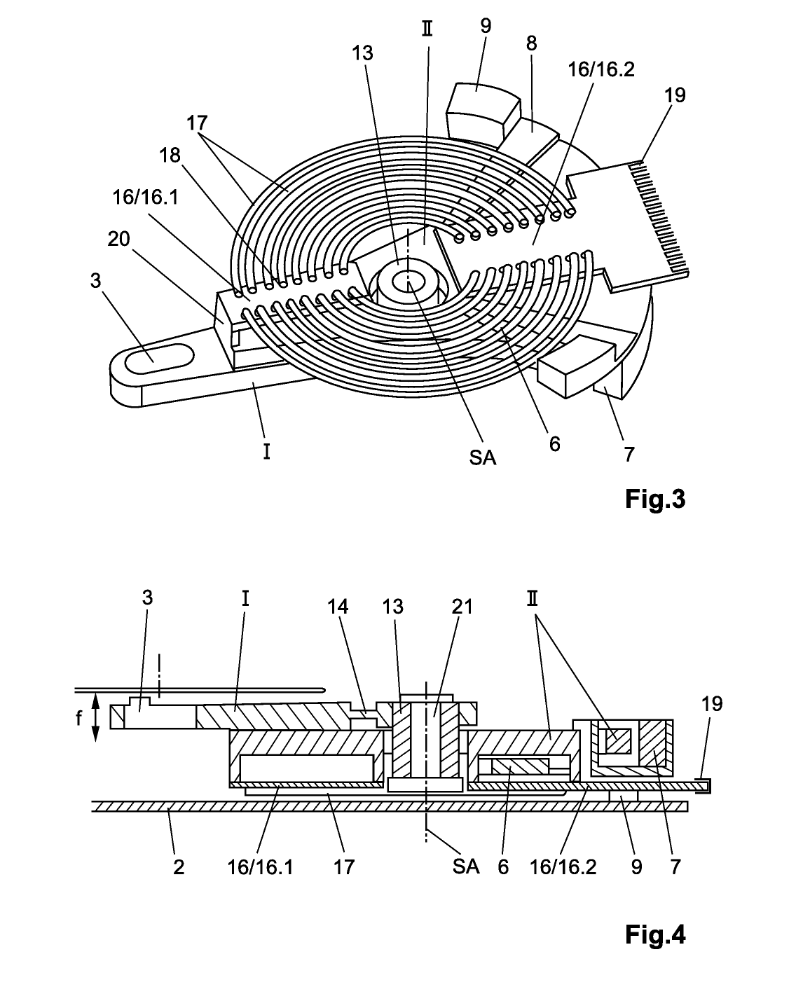

FIG. 3 is a bottom view thereof, in perspective;

FIG. 4 is a longitudinal sectional view of the suspension arm actuator;

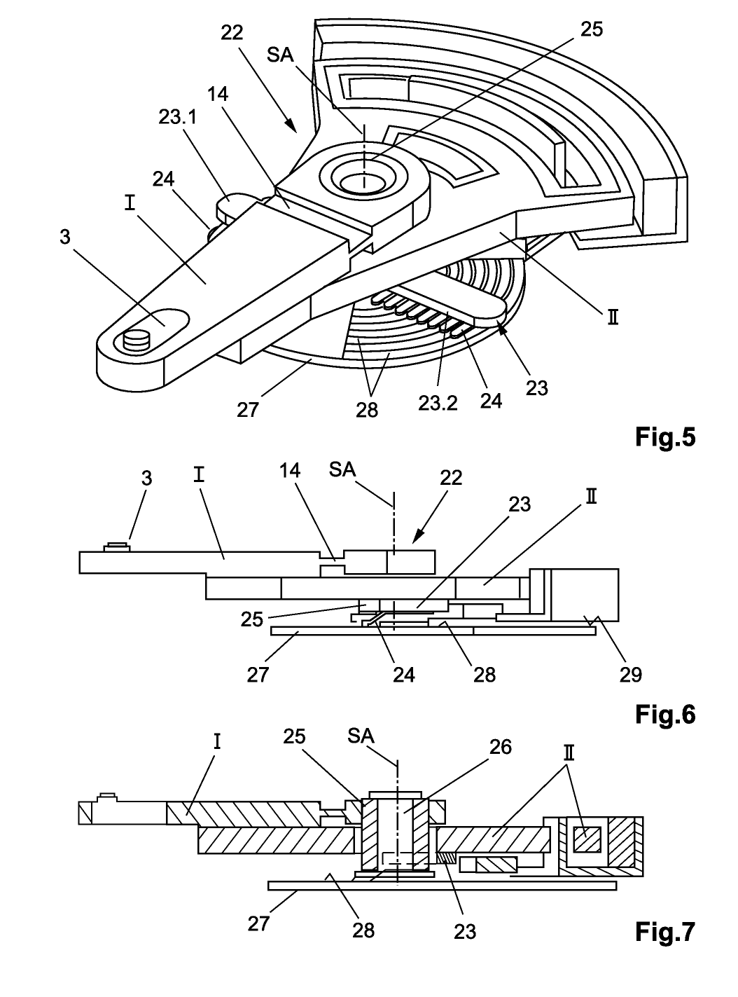

FIG. 5 is a top view of a suspension arm actuator with a sliding brush arrangement, in perspective;

FIG. 6 is a lateral view thereof; and

FIG. 7 is a longitudinal sectional view of this suspension arm actuator.

Referring to FIGS. 1 and 2, the suspension arm actuator for an optical scanning device, not shown, comprises a torsionally stiff suspension arm 1 which has a two-arm-lever-type design and is, in its center of gravity CG, mounted to a support, FIG. 4, between the lever arms I and II such that it can be pivoted about a pivot axis PA extending perpendicularly to said suspension arm. At its end side, the lever arm I supports an optical head 3 having a number of optical components, not shown, in particular an objective lens. Two printed coil arrangements 4 and 5 which are operably connected to the magnets 6 and 7 and form with these (6, 7) magnetic drives for the suspension arm 1 are arranged on the other lever arm II, said magnets 6 and 7 being permanently attached to the support and allocated to said coil arrangements 4 and 5. The magnets are attached to the support 2 by means of holding webs 8 which are connected to said magnets and provided with bearing blocks 9 arranged on the side of the support.

This lever arm II comprises an edge region 10 extending coaxially in relation to the pivot axis PA and having a coaxially designed recess 11 spaced apart from said edge region 10, said recess 11 being surrounded by a printed coil 5 on each of its upper and bottom sides. A leg of a U-shaped yoke 12 connected to the magnet 7 is engaged in the recess 11 in a non-contacting manner, wherein the magnet 7 itself coaxially encloses the edge region 10 on the latter's outside with play. The magnetic drive formed in this manner initiates a motion of the suspension arm 1 perpendicular to the pivot plane in focusing direction f. In the region between this first magnetic drive 5, 7 and the pivot axis PA, the magnet 6 that has the form of a ring section and is permanently attached to the support is arranged coaxially in relation to the pivot axis PA and spaced apart from the suspension arm 1. Two coils 4 that are adjusted to the coaxially curved shape of and are corresponding with said magnet 6 are allocated to said magnet 6 as well, wherein one of these coils is arranged on the upper side and the other one on the bottom side of the suspension arm 1. The second magnetic drive that is formed by these coils 4 and said magnet 6 serves to generate a swivel motion of the suspension arm 1 about the pivot axis PA, in tracking direction t, radially in relation to an optical disk.

Contrary to the lever arm II, the lever arm I supporting the optical head 3 is connected to a bearing bush 13 in a non-rotatable manner and comprises an elastically bendable region 14 in order to move said head 3 in focusing direction f perpendicularly in relation to the pivot plane. In this region between the optical head 3 and the region 14, the lever arm II is securely connected to this lever arm I, is held exclusively in this region and is, therefore, freely suspended up to its edge region 10 on that side of the bendable region 14 that is facing away from the optical head 3. By means of a groove 15 incorporated on the bottom and upper sides of the lever arm I, the region 14 is considerably reduced as compared with the thickness of this lever arm I and is, in its thickness, designed such that the head-sided part of the otherwise rigid lever arm I is moved in focusing direction f once the lever arm II is exposed to the effect of the first magnetic drive formed by the magnet 7. The secure connection of the two lever arms I and II is also used to initiate the swivel motion of the lever arm I about the swivel axis PA as a result of a swivel motion of the lever arm II which is caused by the second magnetic drive formed by the magnet 6, thus initiating a swivel motion of the complete suspension arm 1.

Referring now to FIGS. 2 and 3, a two-part contact crosspiece 16 comprising crosspiece parts 16.1 and 16.2 and lines, not shown, integrated in said crosspiece parts 16.1 and 16.2 is permanently arranged at projections 20, see also FIG. 4, formed on said lever arm II, on that side of the lever arm II that is facing away from the lever arm I, that is on the bottom side of said lever arm II and, therefore, on the side of the support. Said contact crosspiece 16 extends in the direction of the longitudinal axis of the suspension arm 1, wherein the former's parts 16.1 and 16.2 are each arranged on either side of the bearing bush 13 which, together with a pivot pin 21 permanently arranged on the support 2, FIG. 4, forms a pivot bearing. As is the case with the lever arm II, the parts 16.1 and 16.2 are not connected to the bearing bush 13 either. Line wire sections 17 formed coaxially in relation to said bearing bush and having the form of a ring section are arranged between the parts 16.1 and 16.2 and, through contact areas 18, are electrically connected to lines integrated in said parts 16.1 and 16.2. Therein, the line wire sections 17, self-supporting and singly separated and spaced apart from each other, are arranged in a plane extending in transverse direction in relation to the pivot axis PA and are arranged between the lever arm II and the plane that is defined by the bearing surfaces of the bearing blocks 9 on the support 2, FIG. 4, or by said support and are movable above said support 2. Contact areas 19 are applied to the part 16.2 on that of the latter's ends that is facing away from the optical head 3, said contact areas 19 each being connected to an electric line integrated in said part 16.2 and a connection line running to a control unit, not shown, being connectable to each of said contact areas 19. The lines integrated in the part 16.1 and electrically connected to the line wire sections 17 are connected to the optical components in the head 3 through lines integrated in the lever arm II and the lever arm I. On the side of the support, the line wire sections 17 are, therefore, arranged at the lever arm II of the suspension arm 1 and move with said lever arm II. The sectional view of FIG. 4 illustrates the arrangement of the line wire sections 17 and also shows the arrangement of the suspension arm actuator on the support 2.

FIGS. 5 to 7 show a further embodiment of a suspension arm actuator. A contact crosspiece 23 is permanently arranged on the lever arm II of the suspension arm 22 on the side facing away from the lever arm I and in transverse direction in relation to the longitudinal axis of the lever arm I. At the two arms 23.1 and 23.2 of said contact crosspiece 23, line sections 24 on either side of the longitudinal axis are each in coaxial contact with a pivot bearing formed by a bearing bush 25 and a pivot pin 26, FIG. 7, and are connected to lines, not shown, integrated in these arms 23.1 and 23.2 through the particular contact areas. Therein, the line sections 24 are designed as sliding contacts cooperating with contact tracks 28 concentrically printed on a printed circuit board 27. At the same time, the printed circuit board 27 is a support for the pivot pin 26 and, therefore, for the suspension arm actuator as well. At that end of the printed circuit board 27 that is facing away from the optical head 3, the concentric contact tracks 28 are angular and brought in parallel arrangement with each other and, on the end side, are provided with contact areas 29 for the connection of control lines running to a control unit. In this embodiment, the lines integrated in the contact crosspiece are also in contact with lines running in the lever arms I and II and to the individual optical components in the optical head. In this manner, an electric connection between the control unit and the optical components is constantly established, irrespective of the angular position or a swivel motion of the suspension arm 22 and the contact crosspiece 23 which is securely connected to said suspension arm 22 opposite to the printed circuit board 27.

### LIST OF REFERENCE SYMBOLS USED

1 Suspension arm
2 Support
3 Optical head
4 Coil
5 Coil
6 Magnet
7 Magnet
8 Holding web
9 Bearing block
10 Edge region
11 Recess
12 Yoke
13 Bearing bush
14 Bendable region
15 Groove
16 Contact crosspiece
16.1 Part (of contact crosspiece)
16.2 Part (of contact crosspiece)
17 Line wire section
18 Contact area
19 Contact area
20 Projection
21 Pivot pin
22 Suspension arm
23 Contact crosspiece
23.1 Arm (of contact crosspiece)
23.2 Arm (of contact crosspiece)
24 Line section
25 Bearing bush
26 Pivot pin
27 Printed circuit board
28 Contact track
29 Contact area
I Lever am
II Lever arm
PA Pivot axis
f Focusing direction
t Tracking direction

1. A suspension arm actuator for a scanning device, comprising a suspension arm designed as a two-arm lever, which is allocated to an optical recording carrier and mounted to a support between the lever arms such that it can be pivoted about an axis extending perpendicularly to the suspension arm, wherein one of the lever arms supports at its end side an optical head having an objective lens and a magnetic drive initiating a swivel motion about the axis is allocated to the other lever arm, and further comprising a magnetic drive initiating a motion perpendicular to said swivel motion as well as electric connections between a control unit and the electrical and optical components, wherein the electric connections are established by means of line sections which are arranged on the suspension arm in a plane extending in transverse direction in relation to the axis radially spaced apart from the axis and spaced apart from each other and which are each electrically connected to a contact element for connection of a control line running to a control unit.

2. The suspension arm actuator according to claim 1, wherein the line sections are arranged at a two-part contact crosspiece which is attached to the suspension arm and provided with integrated lines, with the parts of said contact crosspiece being formed on either side of the pivot bearing, however, without being mechanically connected thereto.

3. The suspension arm actuator according to claim 2, wherein the contact crosspiece is arranged on that side that is facing the support for the suspension arm.

4. The suspension arm actuator according to claim 2 wherein the contact crosspiece is arranged on the suspension arm in a non-rotatable manner and is extending in the direction of the longitudinal axis of the suspension arm, that the line sections are each arranged on either side of the longitudinal axis, coaxially to the pivot bearing and between the two parts and in contact with the lines integrated in said parts, and that the part that is facing away from the optical head comprises, at its free end, contact elements for the control lines.

5. The suspension arm actuator according to claim 4, wherein the line sections are self-supporting wire lines.

6. The suspension arm actuator according to claim 3 wherein the contact crosspiece is, on the side of the support, held at projections arranged on the suspension arm.

7. Suspension arm actuator according to claim 2 wherein the contact crosspiece is arranged on the suspension arm in a non-rotatable manner and is extending in transverse direction in relation to the longitudinal axis thereof, that the line sections are each arranged on either side of the longitudinal axis, coaxially to the pivot bearing and at the two parts and in contact with the lines integrated in said parts, that the line sections are designed as sliding contacts cooperating with counter-sliding contacts arranged concentrically on a printed circuit board permanently attached to the support, said counter-sliding contacts at a free end leading into contact elements for the control lines or being designed to form such contact elements.

8. The suspension arm actuator according to claim 7, wherein the printed circuit board is, at the same time, the support for the suspension arm.

9. The suspension arm actuator according to, claim 2, wherein the electric connection between the line sections and the optical and electrical components is established through integrated lines.

10. The suspension arm actuator according to claim 2, wherein said suspension arm actuator and an optical scanning device formed with said suspension arm actuator are used in a device for reading of and/or writing to optical storage media.
